(19) United States
(12) Patent Application Publication
(10) Pub. No.: US 2018/0094217 A1
(43) Pub. Date: Apr. 5, 2018

(54) METHOD AND MATERIAL FOR CLEANING METAL SURFACES

(71) Applicant: GENERAL ELECTRIC COMPANY, Schenectady, NY (US)

(72) Inventors: Evan Jarrett Dolley, Niskayuna, NY (US); Eric Scott Huron, West Chester, OH (US); John Matthew Powers, Independence, KY (US); Nicole Jessica Tibbetts, Delanson, NY (US)

(21) Appl. No.: 15/281,281

(22) Filed: Sep. 30, 2016

(51) Int. Cl. C11D 7/08; C11D 7/14; C11D 7/10; C11D 11/00; C23G 1/02; B08B 3/10; B08B 3/08; B08B 1/00; F01D 25/00

(52) U.S. Cl. CPC C11D 7/08; C11D 7/14; C11D 7/10; C11D 11/0041; F01D 25/002; B08B 3/10; B08B 3/08; B08B 1/002; B08B 1/003; C23G 1/02

(57) ABSTRACT

A cleaning composition, and method for use of the cleaning composition to clean metal surfaces, such as the surfaces of turbomachinery components, is presented. For example, a method includes contacting a surface of an article with a cleaning composition, wherein the article comprises a metal and wherein the surface includes an oxide; and removing the cleaning composition from the surface. The cleaning composition has a viscosity of at least 10⁴ poise, and comprises a thickening agent and an acidic matrix having selective reactivity with the oxide.

### BACKGROUND

This invention relates broadly to a method for removing engine deposits from turbine components using a cleaning composition. This invention further broadly relates to a cleaning composition for use in this method.

In a gas turbine engine, air is drawn into the front of the engine, compressed by a shaft-mounted compressor, and mixed with fuel. The mixture is burned, and the hot exhaust gases are passed through a turbine mounted on the same shaft. The flow of combustion gas turns the turbine by impingement against the airfoil section of the turbine blades, which turns the shaft and provides power to the compressor. The hot exhaust gases flow from the back of the engine. The hotter the combustion and exhaust gases, the more efficient is the operation of the engine. Thus, there is incentive to raise the combustion gas temperature.

The turbine engine assembly includes, among other components, disks (sometimes termed “rotors”) and/or shafts (“spools”) in the compressor and the turbine sections of the engine, a number of blades mounted to the disks/shafts and extending radially outwardly therefrom into the flow path of the air (for the compressor) or the hot gas (for the turbine), and seal elements that channel the airflow used for cooling certain components such as turbine blades and vanes. As the maximum operating temperature of the turbine engine increases, the turbine disks/shafts and seal elements are subjected to higher temperatures. As a result, oxidation and corrosion of the disks/shafts and seal elements have become of greater concern.

Turbine engine components for use at the highest operating temperatures are typically made of nickel and/or cobalt-based superalloys selected for good elevated temperature toughness and fatigue resistance. They have resistance to oxidation and corrosion damage, but that resistance is not sufficient to completely protect them at the operating temperatures now being reached. Over time, engine deposits, such as (but not limited to) nickel oxides and/or aluminum oxides, can form a coating or layer on the surface of these turbine components. These engine deposits typically need to be cleaned off or otherwise removed. Other components, especially those that operate at comparatively lower temperatures, may be made of other alloy types, such as titanium or steel; these components may also become oxidized during service.

Accordingly, it would be desirable to be able be able to effectively and efficiently clean and remove engine deposits, especially engine deposits comprising metal oxides, from machine components that comprise metals, such as nickel and/or cobalt-containing base metals. It would be especially desirable to be able to clean and remove such engine deposits in a manner that does not excessively or substantially remove or alter the base metal of the component. It would further be desirable to be able to formulate a composition that is effective and efficient in cleaning and removing such engine deposits.

### BRIEF DESCRIPTION

Embodiments of the present invention are provided to meet this and other needs. One embodiment is a method for cleaning a surface. The method includes contacting a surface of an article with a cleaning composition, wherein the article comprises a metal and wherein the surface includes an oxide; and removing the cleaning composition from the surface. The cleaning composition has a viscosity of at least 10⁴ poise, and comprises a thickening agent and an acidic matrix having selective reactivity with the oxide.

Another embodiment is a method for cleaning a component of a gas turbine engine assembly. The method includes contacting a surface of a dovetail portion of a turbine disk or turbine blade with a cleaning composition, leaving another portion of the disk or blade substantially free of contact with the cleaning composition; and removing the cleaning composition from the surface. The cleaning composition has a viscosity in a range from about 10⁴ poise to about 10⁶ poise, comprises nitric acid, phosphoric acid, ferric chloride, and fumed silica.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term or terms, such as “about”, and “substantially” is not to be limited to the precise value specified. In some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

In the following specification and the claims, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

Cleaning operations for gas turbine engines often employ chemical means, such as acid solutions, to remove oxides and other engine deposits from components. U.S. Pat. No. 7,115,171 describes examples of such techniques. Although such techniques can be effective, they can be challenging to apply effectively in situations where it is desirable to limit the area over which the cleaning composition used to remove the deposits is in contact with the component. For instance, some components include multiple materials, where one or more of the materials is incompatible with the cleaning composition. As another example, in some components there is a propensity to develop deposits only in specific locations, while other locations on the component remain acceptably free of deposits. In instances such as these, where only selective exposure of the component area to the cleaning composition is desirable, typical processes require additional steps, such as component disassembly, masking procedures, or having to reapply dimensional build up materials and other techniques that add time and expense to the overall cleaning process.

The techniques and materials described herein address this issue at least in part through the use of a cleaning composition of high viscosity relative to conventional liquid cleaning compositions. The viscous composition substantially remains in the region of the part on which it is disposed during the cleaning procedure, thereby providing the ability to clean selected areas of a component without unduly exposing adjacent areas where exposure to a cleaning composition is undesirable or incompatible with component materials.

A method in accordance with the present disclosure includes contacting a surface of an article with a cleaning composition. The article includes a metal, such as a nickel-based superalloy, a cobalt-based superalloy, a steel such as stainless steel, a titanium alloy, or other metal commonly used in machine components. In certain embodiments, the article includes a superalloy, meaning a nickel-based superalloy, iron-based superalloy or cobalt-based superalloy; in particular embodiments, the article includes a nickel-based superalloy. Illustrative nickel and/or cobalt-based superalloys are designated by the trade names INCONEL (e.g., INCONEL 718), NIMONIC, RENE (e.g., RENE 88, RENE 104 alloys), HAYNES, and UDIMET. For example, an alloy that can be used in making turbine disks, turbine shafts, and other useful components is a nickel-based superalloy available under the trade name INCONEL 718 that has a nominal composition, by weight, of 52.5% nickel, 19% chromium, 3% molybdenum, 3.5% manganese, 0.5% aluminum, 0.45% titanium, 5.1% combined tantalum and niobium, and 0.1% or less carbon, with the balance being iron. As another example, a nickel-based superalloy available under the trade name RENE 88DT has a nominal composition, by weight, of 13% cobalt, 16% chromium, 4% molybdenum, 4% tungsten, 2.1% aluminum, 3.7% titanium, 0.7% niobium, 0.03% carbon, and 0.015% boron.

The article may be any metal-bearing item. In certain embodiments, the article is a turbomachinery component, such as a component of a gas turbine engine assembly. Examples of such turbomachinery components that may be employed in the techniques described herein include, without limitation, turbine disks, turbine blades, compressor disks, compressor blades, compressor spools, rotating seals, frames, and cases. The techniques described herein are particularly useful when applied to an article that oxidizes during service, though it will be appreciated that this is not a necessary limitation to the scope of these techniques.

The surface to which the cleaning composition is applied generally includes an oxide, because the cleaning process is aimed to remove at least some of this oxide from the surface of the article. In some embodiments, the oxide includes material formed by oxidation of the metal in the article during service or manufacturing, meaning the oxide includes at least one element derived from the metal of the article. As an example, where the article includes a nickel alloy, the oxide at the surface of the article may include nickel, such as a nickel oxide or a spinel that includes nickel and other elements such as chromium and/or aluminum. The highly alloyed superalloys, such as RENE 88DT, RENE 104, and others, for example, have been found to have increasingly complex oxides with increasing alloying content, for example mixtures of cobalt oxides and spinels and titanium oxides in addition to the more typically seen nickel or chromium or aluminum oxide. The nature of the oxide will depend in part on the composition of the metal at the surface of the article and the environmental conditions (e.g., temperature, atmosphere) under which the oxide formed.

The cleaning composition is designed to have a viscosity that is sufficiently high to avoid undesirable amounts of flow of the composition during the cleaning process. Generally, the composition is formulated to have a viscosity of at least 10⁴ poise to achieve this purpose. The viscosity can be increased above this value if doing so enhances some aspect of the process. For instance, if the surface includes an incline such that gravity increases the risk of unwanted flow, a higher viscosity composition may be desirable. In some embodiments, the viscosity is below about 10⁶ poise; the upper bound on the viscosity may be dictated in part by the requirements of the process by which the cleaning composition is applied to the surface.

Viscosity values described herein typically refer to the value obtained at conditions of temperature and pressure that exist during the cleaning process. Typically, the method is performed at atmospheric pressure, though this is not required. The method may be performed at any temperature; selection of the temperature for any particular instance may depend in part on competing characteristics such as the desire for rapid reaction with/removal of the oxide, which urges toward a higher temperature, and the desire to avoid substantial reaction with the underlying metal of the article, which urges toward a lower temperature. In some embodiments, the contacting step is performed at ambient temperature (such as about 20 degrees Celsius) or above. In some embodiments, the contacting step is performed at a temperature below about 60 degrees Celsius. In certain embodiments, the contacting step is performed at a temperature in a range from about 20 degrees Celsius to about 55 degrees Celsius, and in particular embodiments the range is from about 20 degrees Celsius to about 45 degrees Celsius.

The cleaning composition is formulated to remove the oxide from the surface of the article, while avoiding undesirable levels of reaction with the metal of the article. The minimum amount of oxide to be removed may be specified for a given process, based at least in part on the purpose of the cleaning procedure. For example, where visual inspection of the underlying metal is required, a certain minimum area fraction of oxide may be specified, below which the inspection of underlying metal is deemed ineffective. In the parlance of the art, the term “stock loss” is used to refer to the amount of underlying metal that is removed collaterally during the removal of the oxide. The amount of “stock loss” that can be tolerated in a given process is dictated at least in part by the nature of the component and the region being cleaned; for example, where the region being cleaned is expected to undergo high stress in service, relatively small stock loss may be tolerated to avoid undue weakening of the component. Moreover, in addition to or in place of defining a certain upper limit for stock loss, a given process may specify a certain quality of the surface after cleaning. For example, where a process may specify a thickness threshold, such as 25 microinches (about 0.6 micrometers) for stock loss, it may further specify limits on the presence, number, and/or depth of corrosion pits that may be tolerated, the extent to which intergranular corrosion is allowed, and/or other boundary conditions.

Given the competing constraints of reactivity with the oxide and non-reactivity with the underlying metal, the cleaning composition is formulated to have selective reactivity with the oxide. As used herein, the term “selective reactivity” means that, for a given process, the composition shows acceptable reactivity with the oxide while complying with process specifications for stock loss and other attack of the metal. Those conversant in the art will appreciate that acceptable reactivity with the oxide and acceptable non-reactivity with the metal can be readily determined for a given combination of process conditions and metal compositions.

The cleaning composition, which is typically aqueous, includes an acidic matrix having selective reactivity with the oxide. In some embodiments, the acidic matrix includes a mineral acid, such as nitric acid, phosphoric acid, sulfuric acid, hydrochloric acid, or any combination comprising one or more of these. In particular embodiments, the acidic matrix includes nitric acid and phosphoric acid, which in combination with aqueous solutions has shown attractive levels of selective reactivity when applied to oxidized nickel-based superalloy articles. In some examples of such combinations, the nitric acid is present in the cleaning composition at a concentration in a range from about 95 grams per liter to about 115 grams per liter. In some examples, the phosphoric acid is present in the cleaning composition at a concentration in a range from about 115 grams per liter to about 145 grams per liter.

The cleaning composition may include an active compound. As used herein, the term “active compound” refers to a compound, such as a salt, that provides chemical moieties to the cleaning composition that participate in the removal of the oxide. In some embodiments, the compound includes a halide, such as a chloride. In particular embodiments, the active compound includes ferric chloride, which has provided attractive performance to cleaning compositions applied to oxidized nickel-based superalloy components. The selection of a suitable active compound, and its concentration in the cleaning composition, will depend at least in part of the processing conditions and the nature of the metal and oxide.

As an example incorporating the above description, a particularly useful cleaning composition includes an acidic matrix that comprises an aqueous mixture of ferric chloride, nitric acid, and phosphoric acid. In particular embodiments, the acidic matrix includes from about 140 grams per liter to about 160 grams per liter ferric chloride, from about 95 grams per liter to about 115 grams per liter nitric acid; and from about 115 grams per liter to about 145 grams per liter phosphoric acid, with the balance of the matrix comprising water. Cleaning compositions including the above acidic matrix composition have been shown by the present inventors to be effective on nickel-based superalloy surfaces, but use of these compositions is not necessarily limited to this alloy class.

To achieve the desired levels of viscosity described previously, the cleaning composition further comprises a thickening agent. As used herein, a thickening agent is an additive present in the cleaning composition that imparts a high viscosity relative to a composition lacking such an additive. In some embodiments, the thickening agent is dissolved in the matrix, creating a gel by promoting, for instance, a three-dimensional network of cross-linked material within the liquid matrix. In other embodiments, the thickening agent is granular material that becomes suspended within the matrix, forming a paste. The thickening agent is present in the cleaning composition in an amount effective to produce a desired level of viscosity; the viscosity of the cleaning composition described herein, as noted previously, is generally at least 10⁴ poise.

An inorganic compound that is substantially inert with respect to the acidic matrix, such as, for instance, a plurality of oxide particles, provides one example of a thickening agent that may be suspended in the matrix to form the cleaning composition. Examples of suitable oxide particles include silica, such as fumed silica, and titania, such as fumed titania. The thickening behavior depends in part on the size and amount of particulate suspended within the matrix. Typically, though not necessarily, the nominal size (that is, the median size) of the particles is less than about 0.5 micrometer. In some embodiments, the nominal particle size is in a range from about 0.005 micrometer to about 0.3 micrometer, and in particular embodiments this range is from about 0.007 micrometer to about 0.2 micrometer. Regarding the amount of particulate present, as noted above the amount may be adjusted to provide the desired viscosity level for a given application. In some embodiments the thickening agent is present in the cleaning composition at a concentration of at least about 1 percent by weight. In some embodiments the concentration is up to about 2 percent by weight.

The step of contacting the surface of the article may be accomplished using any technique used in the art for applying cleaning compositions to surfaces. Examples of such techniques include brushing, swabbing, or extruding the composition onto the surface. As noted previously, the viscous nature of the cleaning composition enables application of the composition to selected portions of the article, allowing locally targeted cleaning to occur. Thus, in one embodiment, the contacting step includes disposing the cleaning composition on a portion of the article, leaving another portion of the article substantially free of contact with the cleaning composition. An example of such an embodiment includes an instance in which the article is or includes a disk for a turbine engine assembly; such disks are well known to have a generally annular shaped hub portion and an outermost rim portion (referred to herein as “dovetail region”) shaped into a plurality of dovetails for engaging a respective plurality of turbine blades. In this illustrative example, the cleaning composition may be applied to the dovetail portion (meaning application is to some or all of this portion) of the disk while leaving the remainder of the disk substantially free of contact with the composition. Similarly, turbine blades typically include a dovetail portion in the region of the blade that engages the disk; this dovetail portion (again, some or all of the dovetail portion) of the blade may be selectively contacted with the cleaning composition, leaving other regions of the blade free of contact with the composition. In yet another example, the article is or includes the case or frame for a compressor or turbine; for example, low-pressure turbine cases have a design feature called a rail, where mating parts rest, that oxidizes because it extends into the hot gas path and is difficult to clean. The rail portion of these cases may be selectively contacted with the cleaning composition, leaving other regions of the part free of contact with the composition.

The surface of the article to be cleaned may be prepared prior to being contacted with the cleaning composition. For example, loosely adhered dirt and other debris may be mechanically removed by any means commonly used in the art, such as by directing a j et of air or liquid onto the surface, by scraping or brushing, or by any other convenient technique. In some embodiments, the method further comprises a preparing step that includes applying a chemical preparation to the surface. The application of the chemical preparation may be additional to or an alternative to the mechanical removal of deposits. Various products are commercially available, such as those under the TURCO tradename, for removing oils and solid deposits from engine component. One example of such a chemical preparation is TURCO 4338 brand compound, an alkaline permanganate formulation. Use of formulations of this type may assist in the overall cleaning process by partially reacting with oxides and other engine deposits to render them more readily reactive with the cleaning composition described herein applied during the contacting step. If a preparation step is applied, the surface may be subsequently rinsed to remove debris and/or the chemical preparation prior to contacting the surface with the cleaning composition.

The cleaning composition is left in contact with the surface of the article for a time to allow at least partial removal of the oxide without undue damage to the underlying metal. The cleaning composition is then removed from the surface. Along with the cleaning composition, other material such as loosened oxide, dirt, other engine deposits, and any reaction products that formed due to reaction between the cleaning composition and the oxide may be removed as well. The removing step may be effected by rinsing the contacted area with a solvent, such as water, by mechanically removing the composition, as by wiping, or via any other technique that effectively removes the cleaning composition from the surface. After removing the composition, the sequence of contacting and removing (with or without the preparation step) may be repeated, for example in cases where the amount of oxide removed from the surface is deemed insufficient.

To further illustrate the techniques described above, the following non-limiting example is provided. In this example, a method for cleaning a component of a gas turbine engine assembly includes contacting a surface of a dovetail portion of a turbine disk or turbine blade with a cleaning composition, leaving another portion of the disk or blade substantially free of contact with the cleaning composition. The cleaning composition, which has a viscosity in a range from about 10⁴ poise to about 10⁶ poise, includes nitric acid, phosphoric acid, ferric chloride, and fumed silica. The concentration of these components is any combination of those described above. The composition is later removed from the surface after an appropriate time under contact has elapsed, allowing at least some removal of oxide and/or other engine deposit to occur.

The disclosure above in part presents a method for cleaning metal components using a viscous cleaning composition. The cleaning composition described above is another embodiment of the present invention.

### Examples

The following examples are presented to further illustrate non-limiting embodiments of the present invention.

A turbine blade that had been previously exposed to elevated temperature exhibited oxide in its dovetail portion. The blade was made of a nickel-based superalloy. The blade was first immersed in TURCO 4338 brand alkaline permanganate solution per manufacturer's guidelines for 30 minutes. The blade was removed from the solution and rinsed, then a cleaning composition in accordance with the embodiments described herein was applied to the oxide deposits on the dovetail region using a cotton swab. The aqueous cleaning composition included 250 milliliters of an acidic matrix solution (140-160 g/l ferric chloride+95-115 g/l nitric acid+115-145 g/l phosphoric acid) in which 18.75 g of fumed silica (nominal size 0.007 micrometers) was suspended to form a viscous paste. The cleaning composition was removed from the blade after 15 minutes of contact by rinsing with water. A substantial portion of the oxide deposits was observed to have been removed. The TURCO/paste/removal sequence was repeated, and yet more of the oxide was removed. Damage to the underlying metal of the blade was minimal.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for cleaning a surface, the method comprising:
Contacting a surface of an article with a cleaning composition, wherein the article comprises a metal and wherein the surface includes an oxide; and
Removing the cleaning composition from the surface;
wherein the cleaning composition has a viscosity of at least 10⁴ poise, and wherein the cleaning composition comprises
an acidic matrix having selective reactivity with the oxide, and
a thickening agent.

2. The method of claim 1, wherein the acidic matrix comprises at least one mineral acid.

3. The method of claim 2, wherein the mineral acid comprises nitric acid, phosphoric acid, sulfuric acid, hydrochloric acid, or any combination comprising one or more of these.

4. The method of claim 3, wherein the acidic matrix comprises nitric acid and phosphoric acid.

5. The method of claim 4, wherein the nitric acid is present in the cleaning composition at a concentration in a range from about 95 grams per liter to about 115 grams per liter.

6. The method of claim 4, wherein the phosphoric acid is present in the cleaning composition at a concentration in a range from about 115 grams per liter to about 145 grams per liter.

7. The method of claim 2, wherein the acidic matrix further comprises an active compound.

8. The method of claim 7, wherein the active compound comprises ferric chloride.

9. The method of claim 1, wherein the acidic matrix comprises
from about 140 grams per liter to about 160 grams per liter ferric chloride;
from about 95 grams per liter to about 115 grams per liter nitric acid; and
from about 115 grams per liter to about 145 grams per liter phosphoric acid.

10. The method of claim 1, wherein the thickening agent comprises an inorganic compound.

11. The method of claim 1, wherein the thickening agent comprises a plurality of oxide particles.

12. The method of claim 11, wherein the plurality of oxide particles comprises silica, titania, or any combination including one or more of these.

13. The method of claim 11, wherein the plurality of particles has a nominal size up to about 0.5 micrometer.

14. The method of claim 11, wherein the plurality of particles has a nominal size in a range from about 0.005 micrometer to about 0.3 micrometer.

15. The method of claim 11, wherein the plurality of particles has a nominal size in a range from about 0.007 micrometer to about 0.2 micrometer.

16. The method of claim 1, wherein the viscosity is less than or equal to 10⁶ poise.

17. The method of claim 1, wherein contacting comprises applying the cleaning composition to the surface by brushing, swabbing, or extruding.

18. The method of claim 1, wherein, after the removing step, a sequence comprising the steps of contacting and removing is repeated.

19. The method of claim 1, wherein contacting the surface comprises disposing the cleaning composition on a portion of the article, leaving another portion of the article substantially free of contact with the cleaning composition.

20. The method of claim 19, wherein the article comprises a disk for a turbine engine assembly, and wherein the portion of the article upon which the cleaning composition is disposed comprises a dovetail portion of the disk.

21. The method of claim 1, wherein the article comprises a component of a gas turbine engine assembly.

22. The method of claim 21, wherein the component comprises a turbine disk, a turbine blade, a compressor disk, a compressor blade, a compressor spool, a rotating seal, a frame, or a case.

23. The method of claim 1, wherein the metal comprises a nickel-based superalloy.

24. A method for cleaning a component of a gas turbine engine assembly, the method comprising:
Contacting a surface of a dovetail portion of a turbine disk or turbine blade with a cleaning composition, leaving another portion of the disk or blade substantially free of contact with the cleaning composition; and
Removing the cleaning composition from the surface;
wherein the cleaning composition has a viscosity in a range from about 10⁴ poise to about 10⁶ poise, and wherein the cleaning composition comprises nitric acid, phosphoric acid, ferric chloride, and fumed silica.
